(19) United States
(12) Patent Application Publication
(10) Pub. No.: US 2026/0321120 A1
(43) Pub. Date: Oct. 15, 2026

(54) VEHICLE AND CONTROL METHOD THEREOF

(71) Applicants: Hyundai Motor Company, Seoul (KR); Kia Corporation, Seoul (KR)

(72) Inventor: Xu Qiang SUN, Yantai (CN)

(21) Appl. No.: 19/381,760

(22) Filed: Nov. 6, 2025

(30) Foreign Application Priority Data
Apr. 10, 2025 (CN) 202510445365.3

(51) Int. Cl. G08B 21/02; B60Q 5/00; H04W 4/48

(52) U.S. Cl. CPC G08B 21/0272; B60Q 5/00; H04W 4/48

(57) ABSTRACT

The present disclosure provides a method performed by an apparatus of a vehicle. The method may include establishing a connection between a first portable terminal, carried by a first entity, and an Ultra-Wideband (UWB) transceiver of the vehicle; designating, based on a user input, a safety zone around the vehicle; acquiring, via the UWB transceiver, information indicating a position of the first portable terminal carried by the first entity; causing the vehicle to display the position of the first portable terminal; and causing, based on the position of the first portable terminal being out of the safety zone, the first portable terminal and the vehicle to output an alert. The position may be a relative position of the first portable terminal with respect to the vehicle.

### CROSS-REFERENCE TO RELATED APPLICATION

This application claims priority to Chinese Patent Application No. 202510445365.3, filed on Apr. 10, 2025, the disclosure of which is incorporated herein by reference in its entirety.

### FIELD OF TECHNOLOGY

The present disclosure relates to a method for monitoring an entity position and ensuring safety based on UWB and a vehicle therefor.

### BACKGROUND

Ultra-Wide Band (UWB) is a radio carrier communication technology. A UWB communication device may transmit and receive narrow pulses in nanoseconds or even sub-nanoseconds to transmit data, and one information bit may be mapped into hundreds of pulses, so that the spectrum range occupied is very wide. Since the distance measurement, radar position measurement, and sensitivity are directly proportional to the signal bandwidth, the UWB may implement high-precision position measurement in centimeters.

In the field of automobiles, the number of automobile manufacturers that use UWB as a vehicle specification at the time of delivery is increasing due to characteristics such as high-precision position measurement of UWBs. For example, more and more automotive keys are adopting UWB-based smart keys. A digital key position may be measured based on UWB as an occupant approaches a vehicle and position measurement on a key terminal matching the vehicle may be performed. The key terminal may be provided with a UWB framework-based position measurement label, and the vehicle may be provided with at least three UWB framework-based position measurement anchor points distributed at different positions, so that position measurement may be performed through the UWB framework without the need to calibrate various key terminals having different antenna parameters, thereby saving time and cost required for terminal calibration work, and position measurement accuracy is high enough to reach a millimeter level, thereby allowing for timely response.

As vehicle-mounted UWBs become increasingly common, how to make the most of vehicle-mounted UWBs has become a future research issue.

The matters described in this Background section are only for enhancement of understanding of the background of the disclosure, and should not be taken as acknowledgement that they correspond to prior art already known to those skilled in the art.

### SUMMARY

Circumstances in which a vehicle user uses a vehicle include outdoor picnics and camping where a family takes a car. When a guardian (second entity) goes on an outdoor picnic with a child (first entity), the child may be fascinated by unfamiliar environments outside, such as clear billboards, attractive rides, lakes, rivers, and reservoirs. These external factors stimulate the child's curiosity and interest and makes them want to explore these novel things, but the guardian is worried that the child may face various dangers if he or she wanders out of the sight of the guardian.

In this regard, a conceivable solution is for the guardian to designate a safety zone so that the child may be active in the safety zone, and if the child is out of the safety zone, to caution the child not to cross the boundary and to remind the guardian that the child has crossed the boundary.

In order to implement the above solution, the present disclosure is based on a vehicle-mounted UWB technology, a guardian, who is a vehicle owner, designates a safety zone by using a vehicle or a portable terminal such as a smartphone in his or her possession, so that a child is allowed to be active in the safety zone, a position of the child may be accurately monitored, and when the child is out of the safety zone, the child may be reminded not to be out of the boundary and the guardian may be reminded that the child is out of the boundary, thereby ensuring the safety of the child.

According to one or more example embodiments of the present disclosure, a method performed by an apparatus of a vehicle may include: establishing a connection between a first portable terminal carried by a first entity, and an Ultra-Wideband (UWB) transceiver of the vehicle; designating, based on a user input, a safety zone around the vehicle; acquiring, via the UWB transceiver, information indicating a position of the first portable terminal carried by the first entity; causing the vehicle to display the position of the first portable terminal; and causing, based on the position of the first portable terminal being out of the safety zone, the first portable terminal and the vehicle to output an alert. The position may be a relative position of the first portable terminal with respect to the vehicle.

Designating the safety zone may include: designating the safety zone via a second portable terminal of a second entity or via the vehicle. The method may further include: transmitting, to the second portable terminal of the second entity, information indicating the position of the first portable terminal.

Designating the safety zone may include: designating, based on map information of a parking position of the vehicle, the safety zone by excluding, from the safety zone, a pre-designated dangerous zone in the map information.

The UWB transceiver may continuously acquire position information of the first portable terminal of the first entity without interruption, or acquires the position information at predetermined time intervals.

The alert may be at least one of a voice alert, a visual alert, or a vibration.

According to one or more example embodiments of the present disclosure, a vehicle may include: a Ultra-Wideband (UWB) transceiver configured to: establish a connection with a first portable terminal carried by a first entity; and acquire position information of the first portable terminal of the first entity; a control circuit configured to: transmit, to the UWB transceiver, safety zone around the vehicle ; and receive, from the UWB transceiver, the position information of the first portable terminal; and a display device configured to, based on the position information, display a position of the first portable terminal of the first entity. The control circuit may be further configured to: control, based on the position of the first portable terminal being out of the safety zone, the first portable terminal and the vehicle to output an alert. The position may be a relative position of the first portable terminal with respect to the vehicle.

The control circuit may be further configured to: designate the safety zone via a second portable terminal of a second entity or via the display device, and transmit, to the second portable terminal of the second entity via the UWB transceiver or a communication network, the position information of the first portable terminal.

The control circuit may be further configured to: designate the safety zone based on map information of a parking position of the vehicle.

The UWB transceiver may be further configured to: continuously acquire position information of the first portable terminal of the first entity without interruption, or acquire the position information at predetermined time intervals.

The alert may be at least one of a voice alert, a visual alert, or a vibration.

The first portable terminal may include at least one of: a mobile phone; or a digital watch including a wireless transceiver.

The first portable terminal may include a parental control application configured to be controlled by at least one of: the vehicle, a management server, or a second portable terminal.

According to one or more example embodiments of the present disclosure, a method performed by an apparatus of a vehicle may include: establishing, based on determining that the vehicle is in a power ON status and in a safety mode, a connection between a wireless transceiver, of the vehicle, and a first user device; receiving, from a second user device, an indication of a safety zone designated around the vehicle; receiving, from the first user device via the wireless transceiver, information indicating a position of the first user device; and outputting, based on the position of the first user device being out of the safety zone, a safety alert.

The wireless transceiver may include a Ultra-Wideband (UWB) transceiver.

The method may further include: outputting, via a display device of the vehicle, the position of the first user device.

The first user device may include at least one of: a mobile phone; or a digital watch including a wireless transceiver.

The first user device may include a parental control application configured to be controlled by at least one of: the vehicle, a management server, or the second user device.

Outputting the safety alert may include at least one of: outputting, via a speaker of the vehicle, a sound alert; or transmitting a signal to the second user device to cause the second user device to output a sound alert.

### BRIEF DESCRIPTION OF THE DRAWINGS

FIG. 1 is a schematic diagram of an example vehicle and an example portable terminal implementing a vehicle-mounted UWB-based method of ensuring outdoor child safety.

FIG. 2 is a block diagram illustrating an example hardware structure for implementing a vehicle for ensuring safety of a child outdoors.

FIG. 3 is a flowchart illustrating an example of a process of registering a portable terminal.

FIG. 4 is a flowchart illustrating an example technical solution for outdoor child position measurement.

FIG. 5 is a flowchart illustrating an example of steps of the technical solution of FIG. 4.

FIG. 6 is a schematic diagram illustrating designation of an example safety zone.

FIG. 7 shows an example computing system.

### DETAILED DESCRIPTION

Hereinafter, one or more example embodiments of a vehicle-mounted UWB-based outdoor child safety ensuring method of the present disclosure will be described with reference to the drawings.

In one or more example embodiments of the present disclosure, a first entity may be interpreted as referring to an entity that independently requires separate protection or supervision in an external activity, such as a child, a pet dog, an elderly person, or a disabled person. In the following example embodiment(s), the first entity is mainly represented by a child, but this is not intended to limit the scope of the present disclosure to a specific entity, and is merely an example for clarifying various protection entities to which the present disclosure may be applied.

In one or more example embodiments of the present disclosure, a second entity may be interpreted as referring to an entity that needs to perform responsibility for protection, supervision, or care for the first entity, such as a guardian, an owner of a pet, a caregiver, or the like, or that needs to locate and ensure safety of the first entity. In the following example embodiment(s), the second entity is mainly represented by a guardian, but this is not intended to limit the scope of the present disclosure to a specific entity, and is merely an example for description.

In the following description of the drawings and example embodiment(s), the first entity is exemplified as a child and the second entity as a guardian for convenience, but the scope of the present disclosure is not limited thereto and may be applied to various entities.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

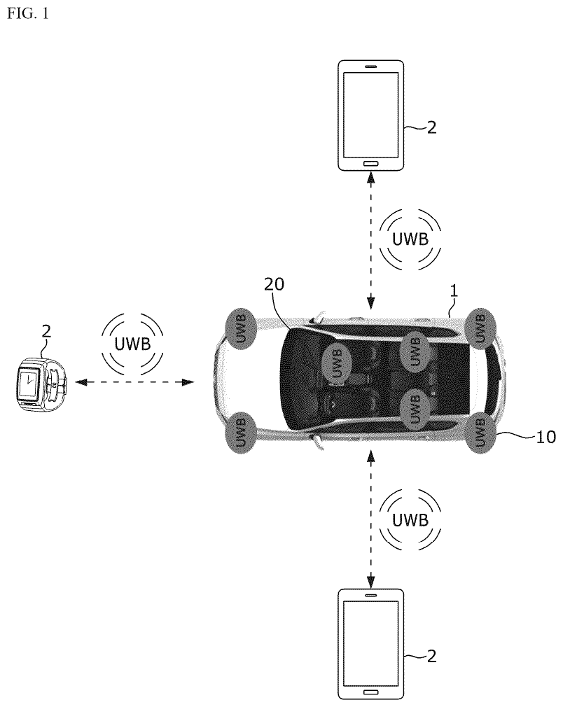

FIG. 1 shows a vehicle 1 and a portable terminal (e.g., user device) 2 that implement a vehicle-mounted UWB-based method of ensuring outdoor child safety.

As shown in FIG. 1, the vehicle 1 includes a vehicle-mounted UWB 10 (e.g., UWB transceiver of the vehicle) and a control unit (also referred to as a control circuit, a controller, etc.) 20. The vehicle-mounted UWB 10 includes a UWB chip configuring a UWB base station for position measurement and a plurality of anchor points distributed in a vehicle body. The control unit 20 is a module for managing various control functions of the vehicle, and may receive information from other modules of the vehicle and transmit signals to corresponding actuators to adjust and control various functions. In the present disclosure, the control unit 20 is for receiving information from the vehicle-mounted UWB 10, generating and transmitting an instruction to the vehicle-mounted UWB 10, and transmitting information and the like to a smart connected system to be described later, and may be, for example, a Body Domain Controller (BDC) provided in the vehicle 1, or may be another processor of the vehicle 1.

The portable terminal 2 is a variety of terminal devices such as a mobile phone (e.g., smartphone) and a digital watch (e.g., smart watch) having a wireless transceiver (e.g., UWB) function, and may transmit and receive information using the UWB and notify or alert a guardian and a child in the form of voice, flash, vibration, and the like. For example, since an adult generally carries a smartphone, a smartphone having a UWB function is suitable for a guardian to use as the portable terminal 2, and since a child may wear a smart watch for a long time, a smart watch having a UWB function may be used as the portable terminal 2 for position measurement of a child. In addition, the child's portable terminal 2 may be a simple device that only has a UWB function and a voice alarm function, and thus may be hung around the child's neck without interfering with the child's activities. The portable terminal 2 may include (e.g., execute, run, etc.) a parental control application. The parental control application may be configured to be controlled by, for example, the vehicle 1, a management server, and/or another portal terminal.

FIG. 1 shows one vehicle and one watch and two portable terminals as the portable terminal 2, of which seven UWB tags are shown at different parts of the vehicle 1. The seven UWB tags of the vehicle 1 represent a UWB chip and a plurality of anchor points, and the number of UWB chips and anchor points and the installation position are not limited. Note that the illustrated one watch and two portable terminals are merely examples, and the type and quantity of the portable terminal 2 are not limited.

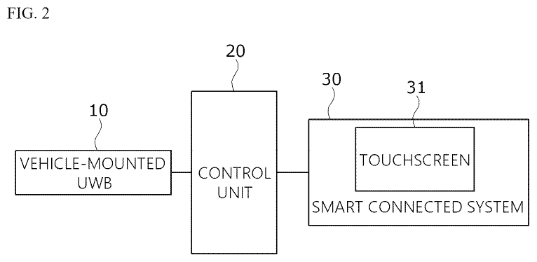

FIG. 2 is a block diagram illustrating an example hardware structure for implementing the vehicle 1 for ensuring safety of a child outdoors.

As shown in FIG. 2, in addition to the vehicle-mounted UWB 10 and the control unit 20, the vehicle 1 further includes a smart connected system 30 including a touchscreen 31. In addition, an operation display unit (e.g., display device) may include at least the touchscreen 31 of the smart connected system 30. The vehicle-mounted UWB 10 and the smart connected system 30 are each connected to the control unit 20 via a bus. The guardian may install an outdoor child position measuring app through a click operation on the touch screen 31, and may enter the app by clicking an icon of the installed app. In addition, since the outdoor child position measuring function may also be used by the guardian in the portable terminal 2, the app may be installed in the portable terminal 2 that needs to use the outdoor child position measuring function of the present disclosure.

For example, the app is also installed on the portable terminal 2 (e.g., smartphone) of the guardian, and when the guardian intends to perform the position measurement of the child outdoors, a safety zone is designated in the app displayed on the touch screen 31 or the portable terminal 2. After the safety zone is designated, the touchscreen 31 or the portable terminal 2 may monitor the current position of the child in real time.

In order to implement the outdoor child safety ensuring method, it is necessary to register the portable terminal 2 in the vehicle-mounted UWB 10 of the vehicle 1 so that the portable terminal 2 and the vehicle 1 are connected (e.g., establish a connection) through the UWB. The registration process is as follows.

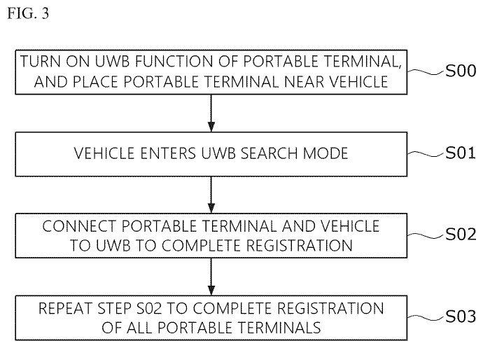

The portable terminal 2 carried by each of the guardian and the child is registered in the vehicle-mounted UWB 10 of the vehicle 1. An example of a registration process is shown in FIG. 3.

As shown in FIG. 3, in step S00, the guardian turns on the UWB communication function of all the portable terminals 2 to be registered, and places the portable terminals 2 near the vehicle 1. This step may be performed, for example, by a guardian and a child carrying the portable terminals 2 and boarding the vehicle 1.

In step S01, the guardian enters an UWB search mode by clicking, for example, an icon displayed on the touchscreen 31 of the smart connected system 30. After entering the UWB search mode, the vehicle-mounted UWB 10 of the vehicle 1 enters a state in which the portable terminals 2 capable of UWB communication within a predetermined range in the vicinity may be searched.

In step S02, the guardian performs the UWB connection between the portable terminal 2 and the vehicle 1. Specifically, when the guardian selects the portable terminal 2 to be registered from the list of retrieved portable terminals 2 displayed on the touchscreen 31 of the smart connected system 30, the vehicle-mounted UWB 10 automatically registers and/or connects the portable terminal 2. At the same time, the guardian and the child proceed to confirm after receiving a notification that the vehicle-mounted UWB 10 will register and/or connect at the portable terminal 2.

After registration of one portable terminal 2 is completed, in step S03, registration of all other portable terminals 2 is performed in the same process as in step S02. Here, the portable terminal 2 carried by the child is marked as the portable terminal 2 of the child at the time of registration.

Through the procedure of the steps S00 to S03 described above, registration of all the portable terminals 2 is completed. The vehicle-mounted UWB 10 records information of all the registered portable terminals 2, and when the registered portable terminal 2 is located within a range in which the vehicle-mounted UWB 10 may be connected and the UWB connection function is turned on, the portable terminal 2 may be automatically connected to the vehicle-mounted UWB 10 of the vehicle 1.

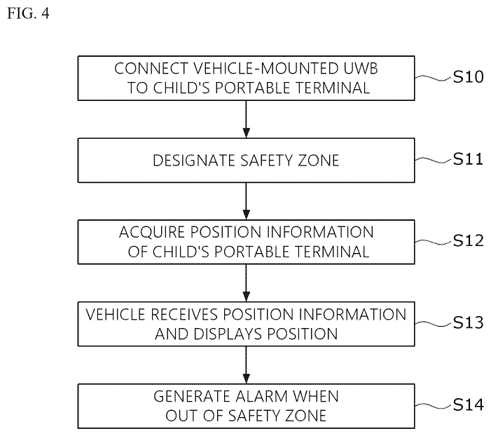

After the portable terminal 2, in particular the portable terminal 2 of the child, is registered, the vehicle-mounted UWB-based outdoor child safety ensuring method may be executed. FIG. 4 illustrates a technical solution for implementing the vehicle-mounted UWB-based outdoor child safety ensuring method, including the following steps. This includes the following steps.

In step S10, the vehicle-mounted UWB 10 is connected to the portable terminal 2 carried by the child. When the guardian is located in the vehicle 1 and the child is alone outside the vehicle, the vehicle-mounted UWB 10 only needs to be connected to the portable terminal 2 carried by the child. When the guardian is outside the vehicle rather than inside the vehicle 1, the vehicle-mounted UWB 10 is preferably connected to the portable terminal 2 carried by the guardian.

In step S11, a safety zone around the vehicle is designated with the vehicle as an origin. The safety zone may be designated by the guardian, for example, by using the touchscreen 31 of the smart connected system 30 of the vehicle 1, or may be designated by using the portable terminal 2 that the guardian carries. The control unit 20 may designate a predetermined area around the vehicle as a safety zone with reference to the vehicle based on the input signal of the guardian.

In step S12, the vehicle-mounted UWB 10 acquires position information of the portable terminal 2 carried by the child, and transmits the detected position information to the vehicle 1. The position information is received, for example, by the control unit 20 of the vehicle 1.

After the vehicle 1 receives the position information, in step S13, the vehicle 1 displays the position of the portable terminal 2 carried by the child indicated by the position information. Specifically, for example, the control unit of the vehicle 1 may transmit the received position information to the touchscreen 31 of the smart connected system 30 to display a position, and the displayed position is a relative position of the portable terminal 2 carried by the child with respect to the vehicle 1.

If it is detected that the position of the child's portable terminal is out of the safety zone, in step S14, both the child's portable terminal 2 and the vehicle 1 generate an alarm (e.g., alert).

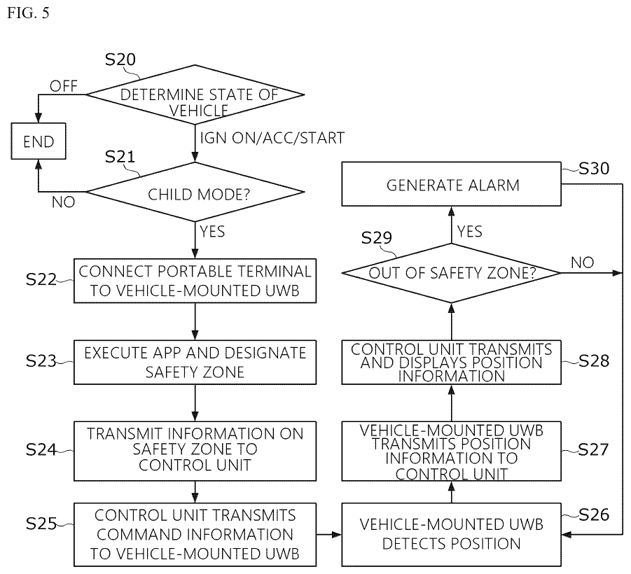

FIG. 4 is a flowchart illustrating an example technical solution for outdoor child position measurement. Hereinafter, an example of more detailed steps in which the vehicle 1 executes the example technical solution will be described with reference to a flowchart of FIG. 5.

In step S20, the control unit 20 determines the power supply state of the vehicle 1, that is, determines whether the touch screen 31 (central control touch screen) of the vehicle 1 is turned on and is in an operable state. When the vehicle 1 is in the unpowered (OFF) state, the outdoor child position measurement may not be performed, and thus the process ends as it is.

When the vehicle 1 is in the “IGN ON” or “ACC” or “START” state, the outdoor child position measurement may be performed, and thus the processing of step S21 is subsequently performed. Here, in the “IGN ON” state, power is supplied to the ignition switch, and both the touchscreen 31 and a dashboard of the vehicle 1 are turned on to operate. In the “ACC” state, the touchscreen 31 of the vehicle 1 is turned on to operate, but the dashboard is not turned on. In the “START” state, not only the touchscreen 31, but also the dashboard are both turned on to operate of the vehicle, but also a start motor is operated to start an engine.

When the vehicle 1 is in an OFF state and the guardian wants to perform the outdoor child position measurement, the vehicle 1 may be ignited in an “IGN ON” or “ACC” or “START” state, and then a subsequent step may be performed.

In step S21, the control unit 20 may determine whether the vehicle 1 is in a child mode. The child mode herein is for performing an outdoor child position measurement mode. When not in the child mode, the processing ends as it is without performing a subsequent step. In the case of the child mode, a subsequent step may be performed. When not in the child mode, when the guardian intends to perform the outdoor child position measurement, the vehicle 1 may be adjusted to the child mode. Here, the step S21 may be omitted, and as long as the vehicle 1 is in the “IGN ON” or “ACC” or “START” state, a default vehicle 1 may be connected to each of the portable terminals 2 through the vehicle-mounted UWB 10 without having to determine whether the default vehicle 1 is in a child mode.

In step S22, the vehicle-mounted UWB 10 of the vehicle 1 is connected to the portable terminal 2 including the portable terminals 2 of the guardian and the child, each of which is registered and located within a connectable range. When the guardian is located inside the vehicle 1, only the child's portable terminal 2 may be connected to the vehicle-mounted UWB 10, and at this time, the guardian may check the position of the child outside the vehicle through the touchscreen 31.

In step S23, the guardian executes the app displayed on the touchscreen 31 or the app installed on the portable terminal 2 to perform subsequent outdoor child position measurement.

After the app is executed, the guardian first designates a safety zone on the touchscreen 31 or the portable terminal 2. The guardian visually checks the environment around the parking place of the vehicle 1, roughly estimates how many meters near the vehicle is the range in which the child may safely move, and then indicates the range in which safe activities are possible on the area map displayed on the touchscreen 31 or the portable terminal 2 to designate a safe area.

The guardian (the second entity) may set the safety zone by using the smart connected system of the vehicle or the app of the portable terminal. In particular, in the process of setting the safety zone, the guardian may draw the safety zone in the form of a certain radius or an arbitrary polygon with the current position of the vehicle as the origin on the touch screen or the map screen of the portable terminal.

In this case, the area set by the guardian on the map (hereinafter referred to as the “navigation setting area”) may be defined based on a unit distance set in advance on the map. For example, the guardian may designate a certain unit length, such as 1 m or 1.5 m, and draw an area on the map based on this to designate a navigation setting area. In this way, the navigation setting area set on the map needs to be matched with the actual position information measured in real time through the vehicle-mounted UWB.

Specifically, the vehicle-mounted UWB may measure the relative distance and the position between the vehicle and the portable terminal carried by the first entity (e.g., a child) in real time by using a reference coordinate system centered on the vehicle. The vehicle-mounted UWB calculates the distance based on the time-of-flight (TOF) of the transmission/reception signal between the UWB anchor point and the UWB tag of the portable terminal carried by the first entity, thereby accurately calculating a relative position information on the two-dimensional coordinate centered on the vehicle.

The control unit may convert the UWB position information measured in real time into the same coordinate system as the coordinate information of the navigation setting area to perform mutual matching. In this way, the control unit may determine whether the first entity is out of the boundary of the set safety zone (the navigation setting area).

More specifically, when the guardian completes the setting (drawing) of the safety zone, the control unit of the vehicle may store the coordinate data of the area in advance to secure the reference coordinates, and when entering the monitoring mode, the drawn safety zone may be activated. The control unit of the vehicle may continuously compare the position signal of the first entity received from the vehicle-mounted UWB, and control to immediately generate an alarm when the position of the first entity exceeds a preset area boundary.

With such a configuration, the precise position measurement result of the vehicle-mounted UWB and the navigation setting area set by the guardian on the map are mutually consistent, and it is possible to more accurately and quickly determine whether the first entity is out of position.

In addition, the app may embed or call map information, and when the guardian designates a safety zone based on the map information, an error due to a distance estimation method may be reduced. Alternatively, the guardian may designate a safety zone based on the map information while visually checking the environment around the parking place of the vehicle 1, and in this way, a safety zone with higher safety may be designated. Further, the safety zone is not limited to a regular figure such as a rectangle or a circle, and may be an irregular polygon or a safety zone whose boundary is not a straight line.

When there is map information, the control unit 20 of the vehicle 1 may recommend a safety zone in advance, and for example, a road, a river, a reservoir, or the like may be displayed as a danger zone to designate a safety zone excluding all danger zones. The safety zone recommended by the control unit 20 may be displayed on the map so that the guardian may select the safety zone. Here, the danger zone may be designated by the guardian itself. For example, when a guardian considers that an aging children's amusement facility is also a risk factor, the aging children's play facility near the vehicle 1 may be indicated as a risk zone.

After the safety zone is designated, in step S24, information on the designated safety zone is transmitted to the control unit 20 of the vehicle 1. After receiving the information on the safety zone, the control unit 20 switches the information to the command information in step S25, and transmits the command information to the vehicle-mounted UWB 10.

In step S26, the vehicle-mounted UWB 10 detects the position of the portable terminal 2 of the connected child. The position here is the relative position of the child's portable terminal 2 relative to the vehicle 1 (e.g., the direction and distance relative to the vehicle 1). The vehicle-mounted UWB 10 may continuously acquire the position information of the child's portable terminal 2 without interruption, or may acquire the position information at intervals according to a predetermined time. The continuously obtained position information without interruption may be used to display the position of the child and generate a movement trajectory at any time, and when detected at a predetermined time, the freshness of the detected position may be ensured as much as possible, and power of the portable terminal 2 carried by the child may be saved.

In step S27, the position information of the child's portable terminal 2 detected by the vehicle-mounted UWB 10 is transmitted to the control unit 20, and in step S28, the control unit 20 transmits the position information of the child's portable terminal 2 to the smart connected system 30 or the guardian's portable terminal 2 to display the position indicated by the position information.

In step S29, the vehicle-mounted UWB 10 determines whether the position of the child's portable terminal 2 is out of the designated safety zone. When it is not out of the range, the process returns to step S26, and the position of the child's portable terminal 2 is continuously detected until the position of the child's portable terminals 2 is out of the safety zone. When it is out of the range,, a step S30 is entered, and the vehicle device capable of making a sound or emitting light, such as the touchscreen 31, and/or the guardian's portable terminal 2, and the child's portable terminal 2 generate an alarm, so as to inform the guardian and the child that the child is out of the safety zone, remind the guardian to pay attention to look at the child, and remind the child to return to a place close to the vehicle 1. The alarm is preferably generated via at least one method of voice (e.g., a voice alert), flash (e.g., a visual alert) and vibration.

In addition, the vehicle-mounted UWB 10 or the control unit 20 may set a threshold time, and when the time during which there is no change in the position of the child's portable terminal 2 exceeds the threshold time, the vehicle-mounted UWB 10 reminds the guardian to pay attention to the situation of the child, so as to prevent the child from carrying the portable terminal 2 on his/her body or an unexpected accident from occurring.

After the alarm occurs, the vehicle-mounted UWB 10 returns to the step S26 to continuously detect the position of the child's portable terminal 2 and execute the subsequent step.

In addition, the position information of the child is not limited to being transmitted to the smart connected system 30 and the portable terminal 2 of the guardian near the vehicle 1 through the vehicle-mounted UWB 10 of the vehicle 1, but may also be transmitted to the portable terminals 2 of other guardians far from the vehicle 1 through a communication network. For example, when the father takes the child out, the mother at home may check the child's position via a smartphone.

In addition, the portable terminal 2 whose position information is confirmed is not limited to the portable terminal 2 of the child, and the child or the guardian may confirm the portable terminal 2 from another guardian, so that the child may quickly find the guardian or one guardian may quickly find the other guardian.

The vehicle-mounted UWB-based outdoor child safety ensuring method and the vehicle for ensuring the safety of a child in the outdoors may be configured such that a guardian, who is a vehicle owner, designates a safety zone by using the vehicle or a portable terminal such as a smartphone in his or her possession, so that the child is allowed to active in the safety zone, and a position of the child may be accurately monitored, so that when the child is out of the safety zone, the child is reminded not to be out of the boundary, and the guardian is reminded that the child is out of the boundary, thereby ensuring the safety of the child.

An example embodiment of the vehicle-mounted UWB-based outdoor child safety ensuring method will be described below.

If a guardian drives a child to the outdoor park to play, after parking a vehicle 1, the guardian has to prepare supplies, food, and the like, and the child may be active in the surroundings. At this time, the guardian may use the vehicle 1 to implement the outdoor child safety ensuring based on the vehicle-mounted UWB to ensure the safety of the child when there is no person to take care of temporarily.

The guardian causes the vehicle 1 to be in the “IGN ON” or “ACC” or “START” state, and wears the watch phone for the child on the wrist of the child. The children's watch phone is registered in advance in the vehicle-mounted UWB 10 of the vehicle 1.

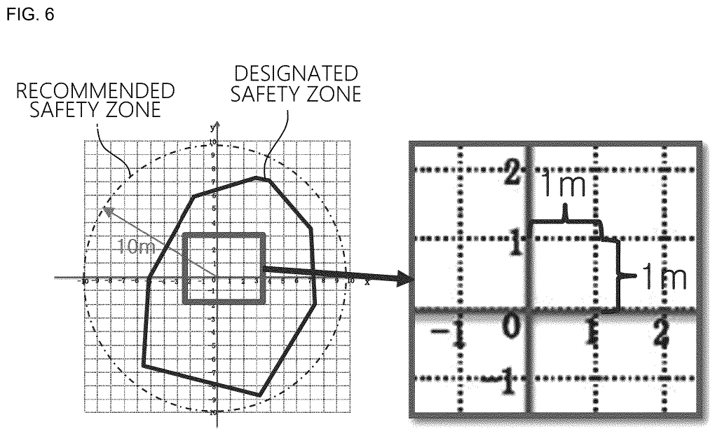

The guardian takes out a smartphone serving as the portable terminal 2, executes the outdoor child position measurement app, and designates a safety zone shown in FIG. 6. FIG. 6 is a schematic diagram illustrating designation of an example safety zone. The guardian first sets a unit length of coordinates whose origin is a position where the vehicle 1 is located on the smartphone, and for example, the unit length may be 1 m. That is, in the area map composed of square grids with coordinates, each square grid represents 1 square meter (see the right part of FIG. 6).

Since the position where the vehicle 1 is located is relatively wide and flat, the app of the smartphone recommends an area within 10 meters from the vehicle 1 as a safety zone, and the safety zone is a circular area indicated by a dotted line on the left side in FIG. 6.

However, the guardian does not want the child to be too far away because they may not afford to care for the child to prepare supplies, food, and the like. The guardian then designates the smartphone with a smaller irregularly shaped safety zone inside the circular area.

The child wears a watch phone for the child and is active in a safety zone designated by the guardian, and the vehicle-mounted UWB 10 of the vehicle 1 detects a position where the watch phone of the child is located once every 30 seconds.

If the child watch phone is out of the safety zone designated by the guardian, the child watch phone reminds the child to return to a place closer to the vehicle 1 in a voice manner. At the same time, the guardian's smartphone also reminds the guardian to pay attention to the child's position in a voice manner.

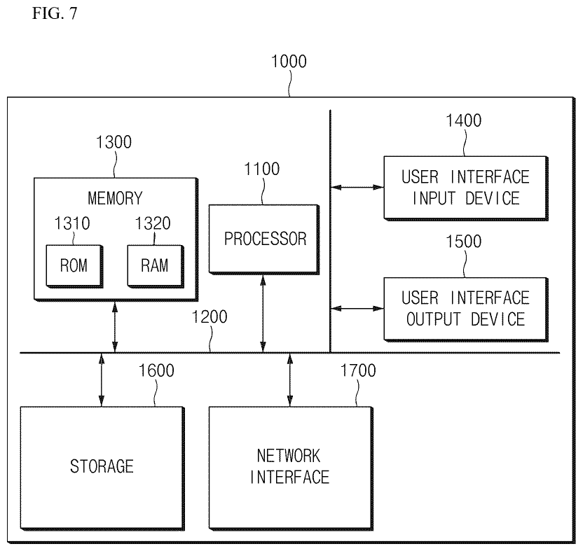

FIG. 7 shows an example computing system (e.g., a computing device of a vehicle or any other apparatus). One or more controllers, processors, etc. described herein (e.g., the vehicle 1, the portable terminal 2, the vehicle-mounted UWB 10, the control unit 20, the smart connected system 30, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as transceiver(s), wireless transceiver(s), communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A control method of a vehicle may include: communicatively connecting a portable terminal carried by a first object to a vehicle-mounted UWB; designating a safety zone around the vehicle with the vehicle as an origin according to a user input; acquiring, by the vehicle-mounted UWB, position information of the portable terminal carried by the first object, and transmitting the position information to the vehicle; receiving, by the vehicle, the position information and displaying a position indicated by the position information; and generating, by both the portable terminal of the first object and the vehicle, an alarm when the position of the portable terminal of the first object is out of the safety zone. In this case, the position indicated by the position information is a relative position of the portable terminal of the first object with respect to the vehicle.

The control method of a vehicle according to some example embodiments, in designating the safety zone, the safety zone may be designated by using a portable terminal of a second object or the vehicle, and the position information acquired by the vehicle-mounted UWB may be transmitted to the portable terminal of the second object.

The control method may generate, based on map information of a parking position of the vehicle, a safety zone excluding a pre-designated dangerous zone on the map.

In the control method of a vehicle, the vehicle-mounted UWB may continuously acquire position information of the portable terminal of the first object without interruption, or acquire it at intervals according to a predetermined time.

In the control method of a vehicle, the alarm may be generated in at least one method of voice, flash and vibration.

A vehicle may include: a vehicle-mounted UWB connected to a portable terminal by a first object to obtain position information of the portable terminal of the first object; a control unit configured to transmit safety zone information around the vehicle, designated based on the vehicle as an origin, to the vehicle-mounted UWB, and receive position information acquired by the vehicle-mounted UWB; and an operation display unit displaying a position of the portable terminal of the first object based on the position information received by the control unit, wherein the control unit may be configured to control both the portable terminal of the first object and the vehicle to generate an alarm when the position of the portable terminal of the first object is out of the safety zone. In this case, the position indicated by the position information may be a relative position of the portable terminal of the first object with respect to the vehicle.

In the vehicle, the safety zone may be designated by using a portable terminal of a second object or the operation display unit, and the position information acquired by the vehicle-mounted UWB may be transmitted to the portable terminal of the second object through the vehicle-mounted UWB or a communication network.

In the vehicle, the control unit may be configured to generate a safety zone for recommendation based on map information of a parking position of the vehicle.

In the vehicle, the vehicle-mounted UWB may continuously acquire position information of the portable terminal of the first object without interruption, or acquire it at intervals according to a predetermined time.

In the vehicle, the alarm may be generated in at least one method of voice, flash and vibration.

According to a vehicle and a method for controlling the vehicle, a guardian, who is a vehicle owner, designates a safety zone by using the vehicle or a portable terminal such as a smartphone in his or her possession, so that the child is allowed to be active in the safety zone, and a position of the child may be accurately monitored, so that when the child is out of the safety zone, the child is reminded not to be out of the boundary, and the guardian is reminded that the child is out of the boundary, thereby ensuring the safety of the child.

In the vehicle-mounted UWB-based outdoor child safety ensuring method and the vehicle for ensuring the safety of a child outdoors of the present disclosure, the guardian, who is the vehicle owner, designates a safety zone by using a smartphone in his or her possession, so that the child may be allowed to be active in the safety zone, and the position of the child may be accurately monitored, so that when the child is out of the safety zone, the child may be reminded not to be out of the boundary and the guardian may be reminded that the child is out of the boundary, thereby ensuring the safety of the child.

What is claimed is:

1. A method performed by an apparatus of a vehicle, the method comprising:
establishing a connection between a first portable terminal, carried by a first entity, and an Ultra-Wideband (UWB) transceiver of the vehicle;
designating, based on a user input, a safety zone around the vehicle;
acquiring, via the UWB transceiver, information indicating a position of the first portable terminal carried by the first entity;
causing the vehicle to display the position of the first portable terminal; and
causing, based on the position of the first portable terminal being out of the safety zone, the first portable terminal and the vehicle to output an alert,
wherein the position is a relative position of the first portable terminal with respect to the vehicle.

2. The method of claim 1, wherein the designating of the safety zone comprises:
designating the safety zone via a second portable terminal of a second entity or via the vehicle, and
wherein the method further comprises:
transmitting, to the second portable terminal of the second entity, information indicating the position of the first portable terminal.

3. The method of claim 1, wherein the designating of the safety zone comprises:
designating, based on map information of a parking position of the vehicle, the safety zone by excluding, from the safety zone, a pre-designated dangerous zone in the map information.

4. The method of claim 1,
wherein the UWB transceiver continuously acquires position information of the first portable terminal of the first entity without interruption, or acquires the position information at predetermined time intervals.

5. The method of claim 1,
wherein the alert is at least one of a voice alert, a visual alert, or a vibration.

6. A vehicle comprising:
a Ultra-Wideband (UWB) transceiver configured to:
establish a connection with a first portable terminal carried by a first entity; and
acquire position information of the first portable terminal of the first entity;
a control circuit configured to:
transmit, to the UWB transceiver, safety zone around the vehicle; and
receive, from the UWB transceiver, the position information of the first portable terminal; and
a display device configured to, based on the position information, display a position of the first portable terminal of the first entity,
wherein the control circuit is further configured to:
control, based on the position of the first portable terminal being out of the safety zone, the first portable terminal and the vehicle to output an alert, and
wherein the position is a relative position of the first portable terminal with respect to the vehicle.

7. The vehicle of claim 6, wherein the control circuit is further configured to:
designate the safety zone via a second portable terminal of a second entity or via the display device, and
transmit, to the second portable terminal of the second entity via the UWB transceiver or a communication network, the position information of the first portable terminal.

8. The vehicle of claim 6, wherein the control circuit is further configured to:
designate the safety zone based on map information of a parking position of the vehicle.

9. The vehicle of claim 6, wherein the UWB transceiver is further configured to:
continuously acquire position information of the first portable terminal of the first entity without interruption, or acquire the position information at predetermined time intervals.

10. The vehicle of claim 6,
wherein the alert is at least one of a voice alert, a visual alert, or a vibration.

11. The vehicle of claim 6, wherein the first portable terminal comprises at least one of:
a mobile phone; or
a digital watch comprising a wireless transceiver.

12. The vehicle of claim 11, wherein the first portable terminal comprises a parental control application configured to be controlled by at least one of: the vehicle, a management server, or a second portable terminal.

13. A method performed by an apparatus of a vehicle, the method comprising:
establishing, based on determining that the vehicle is in a power ON status and in a safety mode, a connection between a wireless transceiver, of the vehicle, and a first user device;
receiving, from a second user device, an indication of a safety zone designated around the vehicle;
receiving, from the first user device via the wireless transceiver, information indicating a position of the first user device; and
outputting, based on the position of the first user device being out of the safety zone, a safety alert.

14. The method of claim 13, wherein the wireless transceiver comprises a Ultra-Wideband (UWB) transceiver.

15. The method of claim 13, further comprising:
outputting, via a display device of the vehicle, the position of the first user device.

16. The method of claim 13, wherein the first user device comprises at least one of:
a mobile phone; or
a digital watch comprising a wireless transceiver.

17. The method of claim 16, wherein the first user device comprises a parental control application configured to be controlled by at least one of: the vehicle, a management server, or the second user device.

18. The method of claim 17, wherein the outputting of the safety alert comprises at least one of:
outputting, via a speaker of the vehicle, a sound alert; or
transmitting a signal to the second user device to cause the second user device to output a sound alert.
